(19) United States
(12) Patent Application Publication
(10) Pub. No.: US 2025/0058465 A1
(43) Pub. Date: Feb. 20, 2025

(54) ROBOT CONTROL DEVICE, CONTROL METHOD, AND NON-TRANSITORY STORAGE MEDIUM

(71) Applicant: TOYOTA JIDOSHA KABUSHIKI KAISHA, Toyota-shi (JP)

(72) Inventor: Yoshihiro OKUMATSU, Toyota-shi (JP)

(73) Assignee: TOYOTA JIDOSHA KABUSHIKI KAISHA, Toyota-shi (JP)

(21) Appl. No.: 18/760,423

(22) Filed: Jul. 1, 2024

(30) Foreign Application Priority Data
Aug. 14, 2023 (JP) 2023-131880

(51) Int. Cl. B25J 9/16; F16F 9/53

(52) U.S. Cl. CPC B25J 9/1651; F16F 9/53; F16F 2230/18

(57) ABSTRACT

A robot control device includes: a speed calculation unit configured to calculate a speed of an output shaft of a drive unit configured to drive a robot; and a compensation value calculation unit configured to calculate a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed detected by the speed calculation unit, and the second viscous resistance being a viscous resistance at a second speed lower than the first speed.

### CROSS-REFERENCE TO RELATED APPLICATION

This application claims priority to Japanese Patent Application No. 2023-131880 filed on Aug. 14, 2023 incorporated herein by reference in its entirety.

### BACKGROUND

### 1. Technical Field

The present disclosure relates to robot control devices, control methods, and non-transitory storage medium.

### 2. Description of Related Art

Japanese Unexamined Patent Application Publication No. 2022-178399 (JP 2022-178399 A) discloses a technique in which a disturbance estimated by a disturbance observer is subtracted from a set control signal and a control signal for an actuator is output. The disturbance observer receives the speed of the actuator fed back from the actuator and the control signal as inputs and estimates the disturbance.

### SUMMARY

There has been a demand for flexible robot arms for coexistence with humans. Robot arms are also expected to operate using for example, machine learning. In order to increase the flexibility of robot arms, it is important to increase the backdrivability of an actuator (ease of movement when the actuator is moved from the outside). In JP 2022-178399 A, it is difficult to achieve sufficient backdrivability because compensation for the control signal for the actuator is performed by feedback control using the disturbance observer for an external force.

The present disclosure provides a robot control device, control method, and non-transitory storage medium that can improve backdrivability.

A robot control device according to an aspect of the present disclosure includes: a speed calculation unit configured to calculate a speed of an output shaft of a drive unit configured to drive a robot; and a compensation value calculation unit configured to calculate a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed detected by the speed calculation unit, and the second viscous resistance being a viscous resistance at a second speed lower than the first speed.

The compensation value calculation unit may be configured to calculate the viscous resistance compensation value based on a following expression when the speed of the output shaft of the drive unit is greater than zero: T_{d}=−k₁×ω²+k₂×ω.

The compensation value calculation unit may be configured to calculate the viscous resistance compensation value based on a following expression when the speed of the output shaft of the drive unit is equal to or less than zero: T_{d}=k₁×ω²+k₂×ω.
In the above expressions, ω is a speed (rad/s),
k₂ is a measured value of a viscous resistance measured in a low speed operation region,
k₁ is k₂/(2ω₀), and
ω₀ is a maximum speed for compensation.

The viscous resistance compensation value may be constant under a condition that the speed of the output shaft is ω₀ or more or under a condition that the speed of the output shaft is −ω₀ or less.

The robot control device may further include an adder configured to add the viscous resistance compensation value to the first torque command to generate the second torque command.

The drive unit may include a motor configured to rotationally drive a joint portion of the robot, and a speed reducer.

The robot may include: an arm portion extending from a body portion and including at least one joint portion at a position that is a predetermined distance or more away from a base of the arm portion; at least one of the drive units configured to generate a driving force for rotationally driving the joint portion; and at least one transmission unit provided between a corresponding one of the joint portions and the drive unit and configured to transmit the driving force of the drive unit to the corresponding joint portion. The drive units may be concentratedly mounted at the base of the arm portion.

The robot may further include at least one rotation detection unit configured to detect rotation information of the drive unit. The speed calculation unit may be configured to calculate the speed based on the rotation information.

A control method according to another aspect of the present disclosure is performed by a computer, and includes:
calculating a speed of an output shaft of a drive unit configured to drive a robot; and
calculating a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed obtained by calculating the speed, and the second viscous resistance being a viscous resistance at a second speed lower than the first speed.

A non-transitory storage medium according to still another aspect of the present disclosure stores instructions that are executable by one or more processors and that cause the one or more processors to perform functions.

The functions include: calculating a speed of an output shaft of a drive unit configured to drive a robot; and calculating a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed obtained by calculating the speed, and the second viscous resistance being a viscous resistance at a second speed lower than the first speed.

The present disclosure provides the robot control device, control method, and non-transitory storage medium that can improve the backdrivability.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view showing a schematic configuration of an arm portion of a robot according to an embodiment;

FIG. 2 is a block diagram showing a schematic configuration of a robot control device according to the embodiment;

FIG. 3 is a flowchart illustrating calculation of a compensation value by a compensation value calculation unit of FIG. 2;

FIG. 4 is a graph showing an example of viscous resistance compensation values.

FIG. 5 illustrates effects of the embodiment;

FIG. 6 illustrates the effects of the embodiment;

FIG. 7 illustrates the effects of the embodiment;

FIG. 8 illustrates the effects of the embodiment; and

FIG. 9 illustrates the effects of the embodiment.

### DETAILED DESCRIPTION OF EMBODIMENTS

Hereinafter, an embodiment of the present disclosure will be described with reference to the drawings. For clarity of description, omissions and simplification have been made as appropriate in the following description and the drawings. Like elements are denoted by like signs throughout the drawings, and repetitive description is omitted as necessary. An example in which the technique of the present disclosure is applied to an arm portion of a robot will be described in the embodiment.

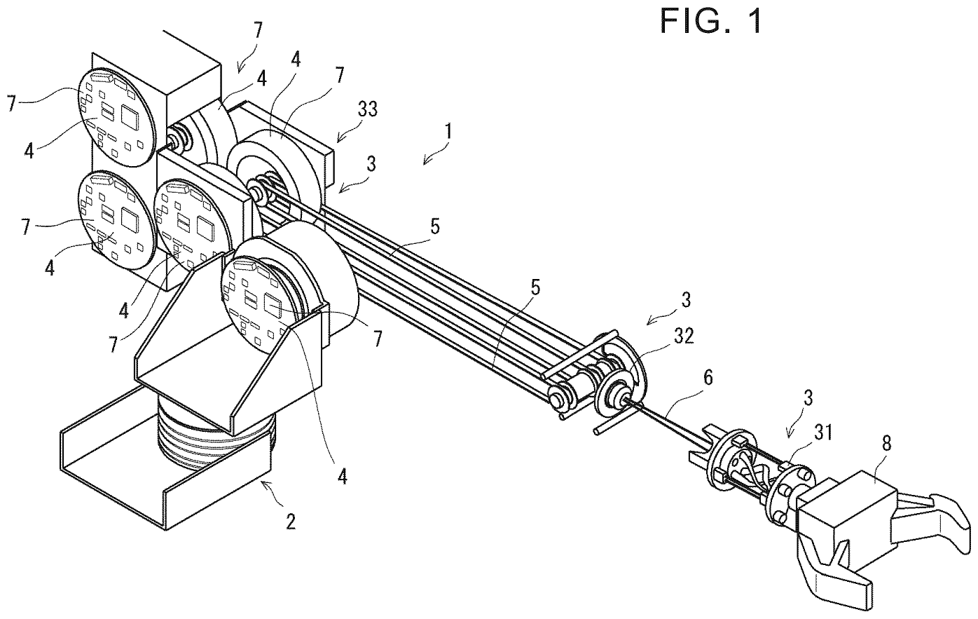

First, a robot arm to which a robot control device according to the embodiment is applied will be described. FIG. 1 is a perspective view showing a schematic configuration of an arm portion 1 of a robot according to the embodiment. The arm portion 1 extends from a body portion 2 of the robot. In the example shown in FIG. 1, the body portion 2 is configured as a base. However, the present disclosure is not limited to this. For example, the body portion 2 may be configured as a torso of a humanoid robot.

The arm portion 1 is configured as a robot arm having one or more joint portions 3 with a link etc. therebetween. The one or more joint portions 3 are located at a position(s) that is a predetermined distance or more away from the base of the arm portion 1. Each joint portion 3 may be configured to rotate about at least one of a yaw axis, a pitch axis, and a roll axis that are perpendicular to each other.

In the example shown in FIG. 1, the arm portion 1 has a wrist joint 31, an elbow joint 32, and a shoulder joint 33. The shoulder joint 33 is located at the base of the arm portion 1. The elbow joint 32 and the wrist joint 31 are located at positions that are the predetermined distance or more away from the base of the arm portion 1. In this example, the wrist joint 31, the elbow joint 32, and the shoulder joint 33 are each configured to rotate about two axes. However, the present disclosure is not limited to this. For example, the wrist joint 31, the elbow joint 32, and the shoulder joint 33 may be configured to rotate about one axis or about three or more axes.

An end effector 8 that can grip an object is mounted at a distal end of the arm portion 1. A plurality of actuators 4 that generates a driving force for driving the individual joint portions 3 is concentratedly mounted at the base of the arm portion 1.

The actuator 4 is a specific example of the drive unit. The actuator 4 may be configured as, for example, a servo motor with a speed reducer. Each actuator 4 generates a driving force that rotationally drives a rotating shaft of the corresponding joint portion 3. In the example shown in FIG. 1, eight actuators 4 that generate a driving force for rotating the wrist joint 31, the elbow joint 32, and the shoulder joint 33 about two axes are concentratedly mounted at the base of the arm portion 1.

For example, as shown in FIG. 1, a belt 5 is wound around each rotating shaft of the elbow joint 32 and the output shaft of each corresponding actuator 4. The belt 5 is a specific example of the transmission unit. The output shaft of each actuator 4 transmits the driving force to each rotating shaft of the elbow joint 32 via the belts 5.

Similarly, a belt 5 is wound around each rotating shaft of the shoulder joint 33 and the output shaft of each corresponding actuator 4. The output shaft of each actuator 4 transmits the driving force to each rotating shaft of the shoulder joint 33 via the belts 5. A wire 6 is wound around each rotating shaft of the wrist joint 31 and the output shaft of each corresponding actuator 4. The output shaft of each actuator 4 transmits the driving force to each rotating shaft of the wrist joint 31 via the wires 6.

In the above example, the belt 5 and the wire 6 are used as the transmission unit. However, the transmission unit is not limited to these. The transmission unit may be, for example, a chain, a gear, or a shaft, or may be any other transmission member that can transmit the driving force of the actuator 4.

An encoder 7 is a specific example of the rotation detection unit. The encoder 7 is provided integrally with the actuator 4. Each encoder 7 detects the rotational position of the output shaft of the corresponding actuator 4. The rotation detection unit is not limited to the encoder 7, and may be another angle sensor.

Conventionally, each joint portion of an arm portion is provided with an actuator. The arm portion is provided with peripheral components such as wires necessary for the actuators. This increases the weight of the arm portion, resulting in a decrease in backdrivability.

In the present embodiment, on the other hand, the actuators 4 are concentratedly provided at the base of the arm portion 1, and power is transmitted using belts and wires. Therefore, there is no need to mount actuators and their peripheral components at the distal end, intermediate portion, etc. of the arm portion 1. This significantly reduces the weight of the arm portion 1, so that the backdrivability of the arm portion 1 can be improved.

In robots, one of main factors that reduce the backdrivability is the influence of the frictions in the actuators 4, particularly in the speed reducers. Torque T_{f} required for backdriving is given by the following expression (1).

$${T}_{f} = {T}_{s} + {I}_{a} \ddot{θ} + {C}_{a} \dot{θ} + {K}_{a} θ \qquad ( 1 )$$

In expression (1), Tₛ is a constant determined by the internal friction of the speed reducer and the self-holding torque of the motor. θ is the rotation angle of the output shaft. Iₐ is a moment of inertia, Cₐ is a viscous friction coefficient, and Kₐ is the rigidity of the drive unit. Improving the backdrivability refers to, for example, reducing the torque T_{f} by reducing one or more of the values Tₛ, Iₐ, Cₐ, and Kₐ in expression (1) physically or by control. Ideally, the inertial resistance, viscous resistance, and frictional resistance of the speed reducer are required to be zero.

As described above, even if the weight of the robot arm is reduced and the backdrivability of hardware itself is improved, the terms in expression (1) cannot be reduced to zero. Therefore, in the present embodiment, the backdrivability is improved by performing compensation by control. In the present embodiment, compensation for the viscous resistance that is a term proportional to the speed out of the terms of the backdrivability is performed.

As described above, the goal is to perform the compensation until the viscous resistance becomes zero. However, performing the compensation to the limit may result in the motor being rotated by the compensation torque due to a parameter error when, for example, the motor has a small viscous resistance. For this reason, the compensation value is usually set to a small value in consideration of variations.

The purpose of performing friction compensation in a human symbiotic robot is to improve the accuracy of detecting an external force when the robot comes into contact with a target object or the surrounding environment when, for example, picking up the target object. Therefore, the region where friction compensation is necessary is limited to extremely low speeds. On the other hand, performing friction compensation up to a high speed range by control requires dealing with nonlinear regions such as hysteresis, high-order fluctuations, etc. This may result in more complex compensators such as high-order compensators, and may result in reduction in compensation capability because safe compensation values are set Therefore, in the present embodiment, friction compensation is designed focusing on the low speed operation range required for human symbiotic robots, as described below. The low speed operation region can be, for example, a speed region lower than 10 to 20 (rad/s).

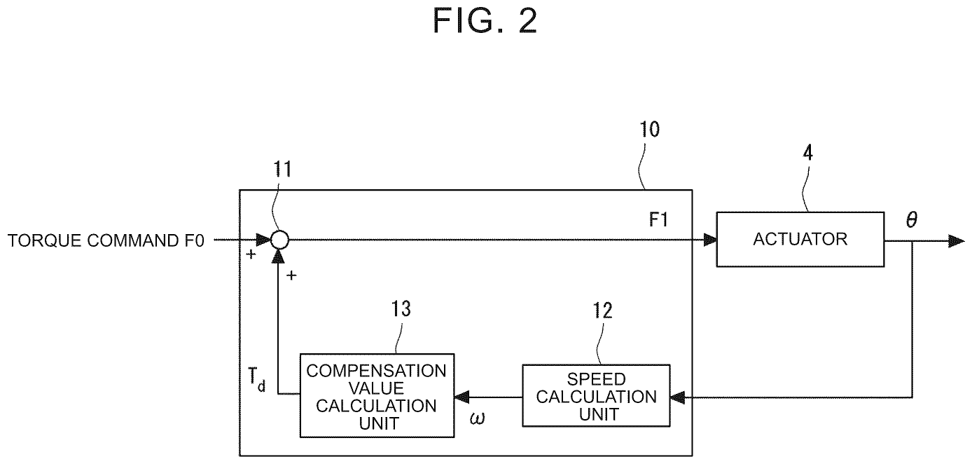

FIG. 2 is a block diagram showing a schematic configuration of a robot control device 10 according to the embodiment. As shown in FIG. 2, the robot control device 10 includes an adder 11, a speed calculation unit 12, and a compensation value calculation unit 13. In the following description, it is assumed that the actuator 4 includes, by way of example, a motor and a gear reducer that uses mechanical meshing to reduce the speed at a high reduction ratio. In the gear reducer, when gears rotate at a predetermined rotational speed, friction is caused by contact between the tips of the teeth of the gears. The robot control device 10 performs feedforward control that cancels the friction caused by the speed reducer by adding a compensation value for compensating for this friction in advance to a torque command to be supplied to the motor.

The adder 11 adds a compensation value T_{d} calculated by the compensation value calculation unit 13, which will be described later, to a set torque command F0, and outputs a torque command F1 to the actuator 4. The speed calculation unit 12 calculates the speed of the output shaft of the actuator 4 from a rotation angle θ of the actuator 4. The rotation angle θ of the output shaft of the actuator 4 can be acquired by an angle sensor such as the encoder 7. The torque command F0 is an example of the first torque command of the present disclosure. The torque command F1 is an example of the second torque command of the present disclosure.

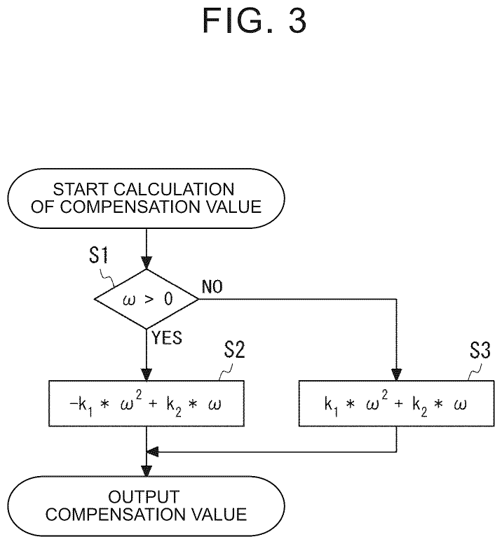

Calculation of the compensation value by the compensation value calculation unit 13 will be described with reference to FIG. 3. First, the speed calculation unit 12 calculates the speed ω of the output shaft of the actuator 4, and inputs the generated speed ω to the compensation value calculation unit 13. As shown in FIG. 3, the compensation value calculation unit 13 first determines whether w is greater than zero (S1).

When the speed ω is greater than zero (S1, YES), a viscous resistance compensation value T_{d} is calculated based on the following Expression (2).

$${T}_{d} = - {k}_{1} \times {ω}^{2} + {k}_{2} \times ω \qquad ( 2 )$$

When the speed ω is equal to or less than zero (S1, NO), the viscous resistance compensation value T_{d} is calculated based on the following Expression (3).

$${T}_{d} = {k}_{1} \times {ω}^{2} + {k}_{2} \times ω \qquad ( 3 )$$

The values in Expressions (2) and (3) are as follows.
ω: speed (rad/s)
k₂: measured value of viscous resistance measured in the low speed operation region

$${k}_{1} : {k}_{2} / ( 2 {ω}_{0} )$$

ω₀: maximum speed for compensation

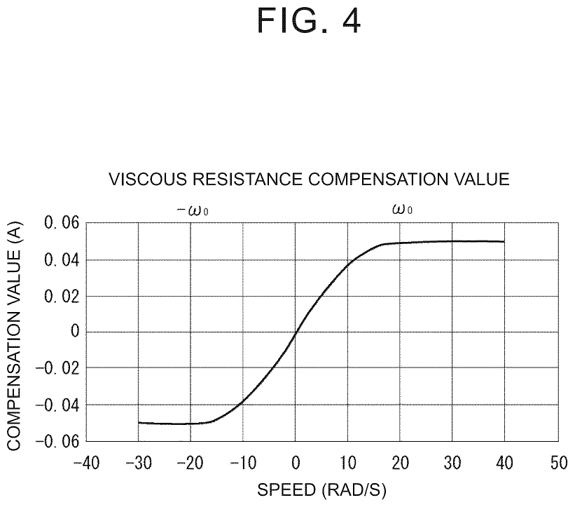

When ω>k₂/2k₁ and ω>−k₂/2k₁, the viscous resistance compensation value T_{d} is the same as the viscous resistance compensation value T_{d} at ω₀. FIG. 4 shows an example of the viscous resistance compensation values calculated in this way. In FIG. 4, it is assumed that the maximum speed do for compensation is, for example, 20 (rad/s). As shown in FIG. 4, the viscous resistance compensation value T_{d} decreases as the speed of the actuator 4 decreases. The viscous resistance compensation value T_{d} is constant at ω₀ or more and at −ω₀ or less.

The robot control device 10 can generate the viscous resistance compensation value T_{d} for compensating for the viscous resistance of the speed reducer of the actuator 4 according to the speed of the output shaft of the actuator 4. The viscous resistance of the actuator 4 can be cancelled by superimposing this viscous resistance compensation value T_{d} on the torque command that is a control voltage for the motor. As described above, the robot control device 10 according to the embodiment can reduce the viscous resistance to closer to zero as the speed of the output shaft of the actuator 4 decreases in the low speed operation region. In other words, the torque command F1 is generated from the torque command F0 so that a second viscous resistance is closer to zero than a first viscous resistance when the first viscous resistance and the second viscous resistance are compared. The first viscous resistance is a resistance when the output shaft has a first speed, and the second viscous resistance is a resistance when the output shaft has a second speed.

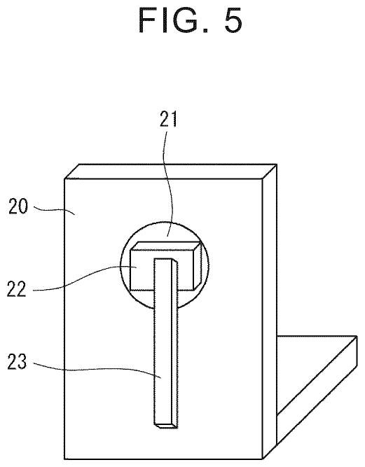

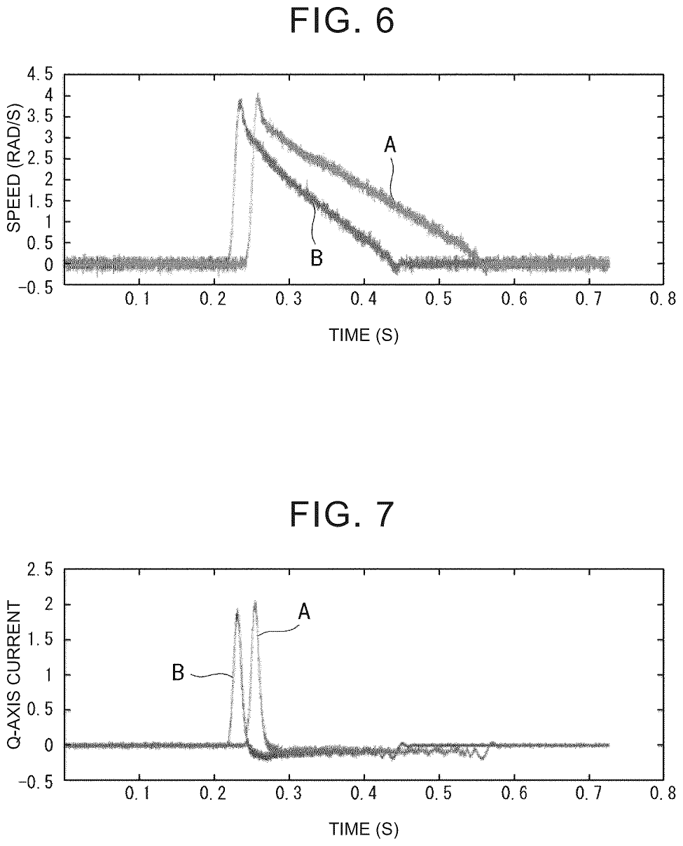

Effects of the control according to the embodiment will be described. FIG. 5 illustrates an example in which a simple collision experiment is performed. In this experiment, an external force is applied to an arm 23 by contact with a hammer, not shown. As shown in FIG. 5, an actuator 21 is mounted on a base 20 having an L shape as viewed from the side. The arm 23 is connected to an output shaft of the actuator 21 via a bracket 22. The results obtained by the operation of the arm 23 when the arm 23 was hit with the hammer (not shown) from the side will be described with reference to FIGS. 6 to 9. In FIGS. 6 to 9, A shows the results when compensation for the viscous resistance was performed, and B shows the results when the compensation was not performed.

FIG. 6 shows the speed of the output shaft of the actuator 21 when the external force was applied by the contact with the hammer. In FIG. 6, the abscissa represents time (seconds) and the ordinate represents speed (rad/s). As shown in FIG. 6, the time during which the arm 23 moved when subjected to the external force is longer when the compensation was performed than when the compensation was not performed. This shows that the backdrivability was improved by the compensation.

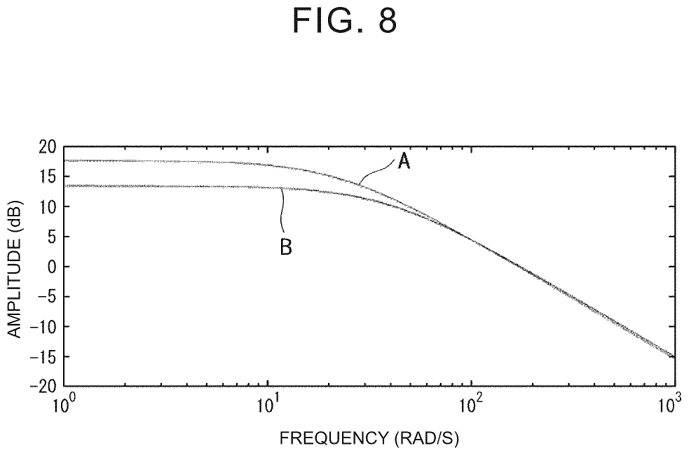

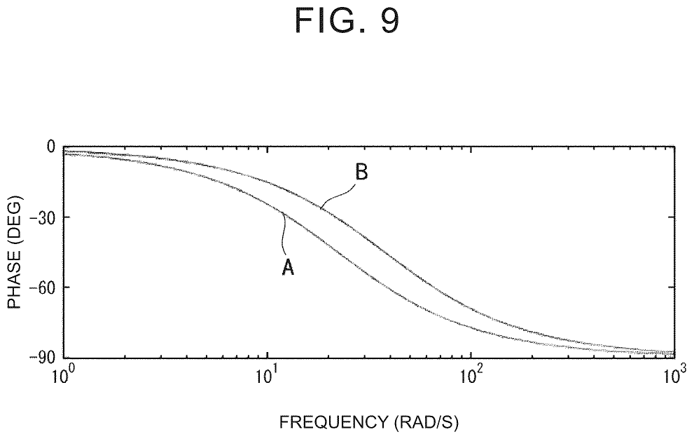

FIG. 7 shows a Q-axis current generated in a motor of the actuator 21 when the external force was applied. Torque is given by the product of the Q-axis current and a torque constant. In FIG. 7, the abscissa represents time (seconds) and the ordinate represents Q-axis current (A). FIGS. 8 and 9 show frequency characteristics based on the speed and torque of the output shaft of the actuator 21. In FIG. 8, the abscissa represents frequency (rad/s) and the ordinate represents amplitude (dB). In FIG. 9, the abscissa represents frequency (rad/s) and the ordinate represents phase (deg). As can be seen from these figures, the amplitudes at lower frequencies are greater when the compensation was performed than when the compensation was not performed, and a cut-off frequency was moved to the low frequency side by the compensation.

As described above, according to the embodiment, the backdrivability can be more effectively improved in a low speed operation region in which a human symbiotic robot mainly operates. As a result, faster responses can be achieved and flexibility of the robot can be increased compared to the case where feedback control is used.

Although the embodiment of the present disclosure is described above, the embodiment is presented by way of example only and is not intended to limit the scope of the present disclosure. This novel embodiment can be carried out in various other modes, and various omissions, replacements, and modifications can be made without departing from the scope of the present disclosure. This embodiment and modifications thereof are included in the scope and gist of the present disclosure, and are included in the scope of the present disclosure described in the claims and equivalents thereof.

In the present disclosure, the various processes illustrated in FIGS. 2 and 3 can also be implemented by, for example, causing a processor to execute computer programs.

The programs can be stored and supplied to the computer by using various types of non-transitory computer-readable media. The non-transitory computer-readable media include various types of tangible recording media. Examples of the non-transitory computer-readable media include a magnetic recording medium (e.g., a floppy disk, a magnetic tape, and a hard disk drive), a magneto-optical recording medium (e.g., a magneto-optical disk), a compact disc read-only memory (CD-ROM), a compact disc-recordable (CD-R), a compact disc-rewritable (CD-R/W), and a semiconductor memory (e.g., a mask ROM, a programmable ROM (PROM), an erasable PROM (EPROM), a flash ROM, and a random access memory (RAM)).

The programs may be supplied to the computer by various types of transitory computer-readable media. Examples of the transitory computer-readable media include electrical signals, optical signals, and electromagnetic waves. The transitory computer-readable media can supply the programs to the computer via a wired communication path such as electric wire and optical fiber, or a wireless communication path.

The parts constituting the robot control device 10 according to the above embodiment need not necessarily be implemented by the programs. Part or all of the parts constituting the robot control device 10 may be implemented by dedicated hardware such as an application-specific integrated circuit (ASIC) or a field programmable gate array (FPGA).

What is claimed is:

1. A robot control device, comprising:
a speed calculation unit configured to calculate a speed of an output shaft of a drive unit configured to drive a robot; and
a compensation value calculation unit configured to calculate a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed detected by the speed calculation unit, and the second viscous resistance being a viscous resistance at a second speed lower than the first speed.

2. The robot control device according to claim 1, wherein the compensation value calculation unit is configured to
calculate the viscous resistance compensation value based on a following expression when the speed of the output shaft of the drive unit is greater than zero,
T_{d}=−k₁×ω²+k₂×ω, and
calculate the viscous resistance compensation value based on a following expression when the speed of the output shaft of the drive unit is equal to or less than zero,
$${T}_{d} = {k}_{1} \times {ω}^{2} + {k}_{2} \times ω$$
where
ω is a speed (rad/s),
k₂ is a measured value of a viscous resistance measured in a low speed operation region,
k₁ is k₂/(2ω₀), and
ω₀ is a maximum speed for compensation.

3. The robot control device according to claim 2, wherein the viscous resistance compensation value is constant under a condition that the speed of the output shaft is ω₀ or more or under a condition that the speed of the output shaft is −ω₀ or less.

4. The robot control device according to claim 1, further comprising an adder configured to add the viscous resistance compensation value to the first torque command to generate the second torque command.

5. The robot control device according to claim 1, wherein the drive unit includes a motor configured to rotationally drive a joint portion of the robot, and a speed reducer.

6. The robot control device according to claim 1, wherein the robot includes
an arm portion extending from a body portion and including at least one joint portion at a position that is a predetermined distance or more away from a base of the arm portion,
at least one of the drive units configured to generate a driving force for rotationally driving the joint portion, and
at least one transmission unit provided between a corresponding one of the joint portions and the drive unit and configured to transmit the driving force of the drive unit to the corresponding joint portion, and
the drive units are concentratedly mounted at the base of the arm portion.

7. The robot control device according to claim 4, wherein
the robot further includes at least one rotation detection unit configured to detect rotation information of the drive unit, and
the speed calculation unit is configured to calculate the speed based on the rotation information.

8. A control method that is performed by a computer, the control method comprising:
calculating a speed of an output shaft of a drive unit configured to drive a robot; and
calculating a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed obtained by calculating the speed, and the second viscous resistance being a viscous resistance at a second speed lower than the first speed.

9. A non-transitory storage medium storing instructions that are executable by one or more processors and that cause the one or more processors to perform functions comprising:
calculating a speed of an output shaft of a drive unit configured to drive a robot; and
calculating a viscous resistance compensation value, the viscous resistance compensation value being a value for generating a second torque command to be output to the drive unit by compensating for a supplied first torque command in such a manner that a second viscous resistance is closer to zero than a first viscous resistance, the first viscous resistance being a viscous resistance at a first speed obtained by calculating the speed, and the second viscous resistance being a viscous resistance at a second speed lower than the first speed.
